(19) United States
(12) Patent Application Publication
(10) Pub. No.: US 2025/0008555 A1
(43) Pub. Date: Jan. 2, 2025

(54) METHOD, DEVICE AND COMPUTER READABLE MEDIUM FOR COMMUNICATIONS

(71) Applicant: NEC CORPORATION, Tokyo (JP)

(72) Inventors: Gang WANG, Beijing (CN); Zhaobang MIAO, Beijing (CN)

(73) Assignee: NEC CORPORATION, Tokyo (JP)

(21) Appl. No.: 18/705,310

(22) PCT Filed: Oct. 29, 2021
(86) PCT No.: PCT/CN2021/127693

§ 371 Date: Apr. 26, 2024

(51) Int. Cl. H04W 74/04; H04W 74/00; H04W 92/18

(52) U.S. Cl. CPC H04W 74/04; H04W 74/002; H04W 92/18

(57) ABSTRACT

Embodiments of the present disclosure relate to methods, devices and computer readable media for communications. A method comprises determining, at a terminal device, a signal duration of an extension signal based on a first variable and a second variable. The method further comprises transmitting the extension signal before performing a sidelink communication.

### TECHNICAL FIELD

Embodiments of the present disclosure generally relate to the field of telecommunication, and in particular, to methods, devices and computer readable media for sidelink communication.

### BACKGROUND

Sidelink in unlicensed spectrum or band (SL-U) is a key topic in Release 18 of the 3rd Generation Partnership Project (3GPP). SL-U should base on New Radio (NR) sidelink and NR-U.

### SUMMARY

In general, example embodiments of the present disclosure provide methods, devices and computer readable media for communications.

In a first aspect, there is provided a method for communications. The method comprises: determining, at a terminal device, a signal duration of an extension signal based on a first variable and a second variable; and transmitting the extension signal before performing a sidelink communication.

In a second aspect, there is provided a method for communications. The method comprises: determining, by a control node device, configuration information about a first variable and a second variable associated with a signal duration of an extension signal; and transmitting the configuration information.

In a third aspect, there is provided a terminal device. The terminal device comprises a processor and a memory storing instructions. The memory and the instructions are configured, with the processor, to cause the terminal device to perform the method according to the first aspect.

In a fourth aspect, there is provided a control node device. The control node device comprises a processor and a memory storing instructions. The memory and the instructions are configured, with the processor, to cause the control node device to perform the method according to the second aspect.

In a fifth aspect, there is provided a computer readable medium having instructions stored thereon. The instructions, when executed on at least one processor of a device, cause the device to perform the method according to the first aspect.

In a sixth aspect, there is provided a computer readable medium having instructions stored thereon. The instructions, when executed on at least one processor of a device, cause the device to perform the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which implementations of the present disclosure can be implemented;

FIG. 2 illustrates an example of automatic gain control (AGC) symbol and guard period (GP) symbol in accordance with some embodiments of the present disclosure;

FIG. 3 illustrates an example of a sub-channel in accordance with some embodiments of the present disclosure;

FIG. 4 illustrates an example of CO sharing in accordance with some embodiments of the present disclosure;

FIG. 5 illustrates a flowchart of an example method in accordance with some embodiments of the present disclosure;

FIGS. 6 to 11 illustrate an example of sidelink transmission in accordance with some embodiments of the present disclosure, respectively;

FIG. 12 illustrates a flowchart of an example method in accordance with some other embodiments of the present disclosure; and

FIG. 13 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

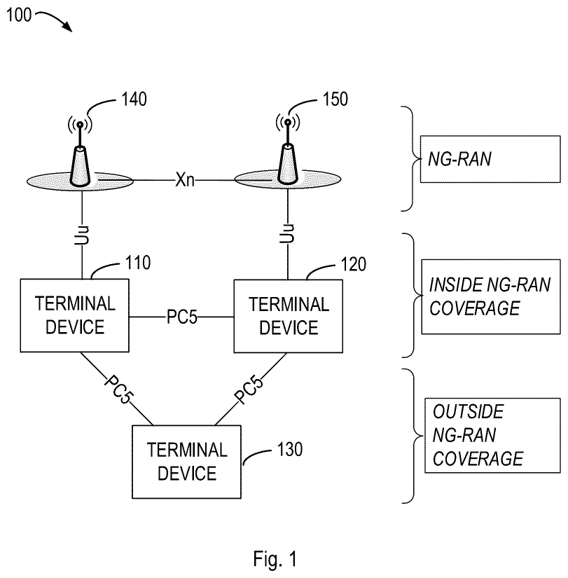

FIG. 1 illustrates a schematic diagram of an example communication network 100 in which embodiments of the present disclosure can be implemented. As shown in FIG. 1, the communication network 100 may include a terminal device 110, a terminal device 120, a terminal device 130, network devices 140 and 150. The network devices 140 and 150 may communicate with the terminal device 110, the terminal device 120 and the terminal device 130 via respective wireless communication channels.

In some embodiments, the network device 140 may be a gNB in NR, and the network device 150 may be an eNB in Long Term Evolution (LTE) system.

It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the communications in the communication network 100 may comprise sidelink communication. Sidelink communication is a wireless radio communication directly between two or more terminal devices, such as two or more terminal devices among the terminal device 110, the terminal device 120 and the terminal device 130. In this type of communication, the two or more terminal devices that are geographically proximate to each other can directly communicate without going through the network device 140 or 150 or through a core network. Data transmission in sidelink communication is thus different from typical cellular network communications, in which a terminal device transmits data to the network device 140 or 150 (i.e., uplink transmissions) or receives data from the network device 140 or 150 (i.e., downlink transmissions). In sidelink communication, data is transmitted directly from a source terminal device (such as the terminal device 110) to a target terminal device (such as the terminal device 120) through the Unified Air Interface, e.g., PC5 interface, (i.e., sidelink transmissions), as shown in FIG. 1.

Sidelink communication can provide several advantages, including reducing data transmission load on a core network, system resource consumption, transmission power consumption, and network operation costs, saving wireless spectrum resources, and increasing spectrum efficiency of a cellular wireless communication system.

In a sidelink communication system, the sidelink resource is used to transmit information between terminal devices. According to application scenarios, service types, etc., a sidelink communication manner includes but is not limited to device to device (D2D) communication, Vehicle-to-Everything (V2X) communication, etc.

V2X communication enables vehicles to communicate with other vehicles (i.e. Vehicle-to-Vehicle (V2V) communication), with infrastructure (i.e. Vehicle-to-Infrastructure (V2I), with wireless networks (i.e. Vehicle-to-Network (V2N) communication), with pedestrians (i.e. Vehicle-to-Pedestrian (V2P) communication), and even with the owner's home (i.e. Vehicle-to-Home (V2H)). Examples of infrastructure include roadside units such as traffic lights, toll gates and the like. V2X communication can be used in a wide range of scenarios, including in accident prevention and safety, convenience, traffic efficiency and clean driving, and ultimately in relation to autonomous or self-driving vehicles.

For sidelink communications, a terminal device uses resources in sidelink resource pools to transmit or receive signals. The sidelink resource pools include resources in time domain and frequency domain, which are dedicated resources of the sidelink communication, or shared by the sidelink communication and a cellular link.

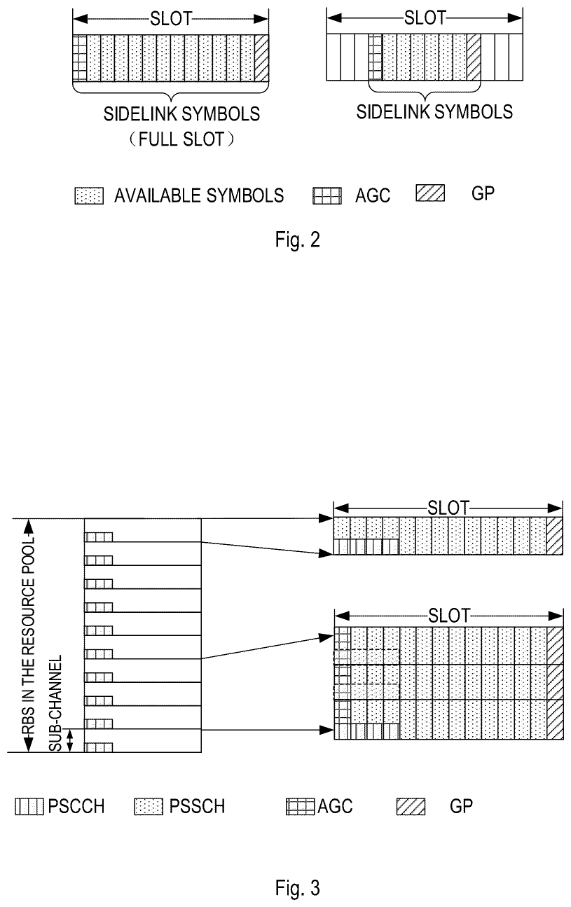

In a sidelink resource pool which may contain multiple slots and resource blocks (RBs), and all or part of the symbols in a slot can be used for sidelink transmission. Within a resource pool, among all the symbols configured for sidelink in each slot, the first symbol (i.e., the start symbol) is used as the automatic gain control (AGC) symbol, and the last symbol used as a guard period (GP) symbol. AGC symbols and GP symbols can be considered as fixed overheads in sidelink resource. In the description of the following embodiments, AGC symbols and GP symbols are included in the sidelink symbols which are indicated by the sidelink channel resource configuration, and AGC symbols carry redundancy sidelink information while GP symbols are not used for carrying sidelink information, as shown in FIG. 2.

The terminal device 110, the terminal device 120 and the terminal device 130 may use sidelink channels to transmit sidelink signaling or information. The sidelink channels include at least one of the following: a Physical Sidelink Control Channel (PSCCH) resource which is used for carrying sidelink control information (SCI), a Physical Sidelink Shared Channel (PSSCH) resource which is used for carrying sidelink data service information, a physical sidelink feedback channel (PSFCH) resource which is used for carrying sidelink ACK/NACK feedback information, a physical sidelink broadcast channel (PSBCH) resource which is used for carrying sidelink broadcast information, and a physical sidelink discovery channel (PSDCH) resource which is used for carrying a sidelink discovery signal.

Within a resource pool, a PSSCH resource includes all the symbols in a slot that are configured as sidelink available symbols, and one or more sub-channels in frequency domain, where each sub-channel contains an integer number of consecutive RBs. The number m of RBs included in one sub-channel is also called the sub-channel size. Each slot contained in the resource pool contains multiple available sidelink symbols, and the PSSCH resource is located in the time domain from the first available sidelink symbol in this slot to all available symbols. In the frequency domain, the resource pool contains multiple RBs, according to the sub-channel size m, starting from the first RB in the resource pool, each m RBs are divided into one sub-channel, and each PSSCH channel resource is located on one or more sub-channels. When one of the terminal device 110, the terminal device 120 and the terminal device 130 uses the PSSCH resource to send sidelink information, it can use one or more sub-channels to carry corresponding data information. A PSCCH resource includes t symbols in time domain, and k RBs in frequency domain. Each PSCCH channel resource is located at consecutive t symbols starting from the first symbol in the available symbols in the time domain, and located at the position of consecutive k RBs starting from the first RB in the corresponding sub-channel in the frequency domain, as shown in FIG. 3.

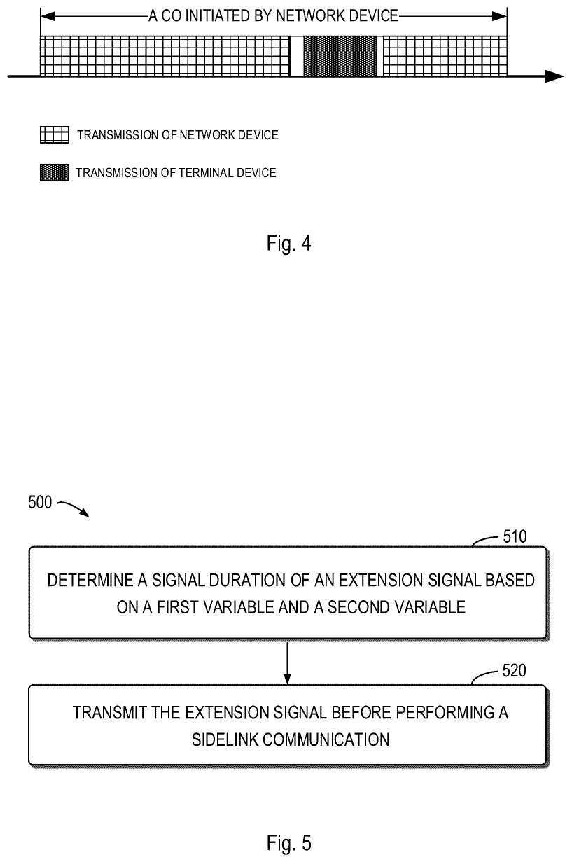

In NR-U schemes, the network device 140 or one of terminal device 110, 120 and 130 may access to a channel in unlicensed spectrum by using a channel access procedure, and obtain a Channel Occupancy (CO). A Channel Occupancy Time (COT) refers to total time for a CO which may be shared between the network device 140 and one of terminal device 110, 120 and 130, as shown in FIG. 4.

For NR-U, when a network device sharing its DL CO with a terminal device, a type of Channel Assess (CA) procedure, Channel Access Priority Class (CAPC) and CPE (Cyclic Prefix Extension) index for uplink transmission are configured per terminal device through a Radio Resource Control (RRC) signaling. The CPE index may comprise one of C1, C2 and C3. C1 is a fixed value, C2 or C3 is configured in an RRC signaling for a terminal device, and then a signal duration of a CPE signal should be determined based on the CPE index and Timing Advance (TA) of the terminal device.

For sidelink communication in unlicensed spectrum, when a sidelink CO is shared among sidelink terminal devices, whether a CPE signal should be transmitted and location and a signal duration of the CPE signal should be considered and determined. In other words, during a sidelink CO initiated by one terminal device, the other terminal device may share a resource in the sidelink CO and determine the signal duration of a CPE signal.

Sharing resources in SL Channel Occupancy (CO) has different requirements and features. In order to coordinate transmission of sidelink terminal devices in a sharing CO, relevant indication or configuration and extension signal scheme should be defined.

Embodiments of the present disclosure provide a solution for sidelink transmission so as to solve the above problems and one or more of other potential problems. According to the solution, a terminal device determines a signal duration of an extension signal based on a first variable and a second variable and transmits the extension signal. In this way, the terminal device may transmit the extension signal before a start symbol of sidelink transmission. By transmitting the extension signal, the terminal device can occupy channel resource in unlicensed spectrum after a channel access procedure succeeds and hold the channel occupancy for following actual sidelink information transmission.

FIG. 5 illustrates a flowchart of an example method 500 in accordance with some embodiments of the present disclosure. In some embodiments, the method 500 can be implemented at a terminal device, such as one of the terminal device 110, the terminal device 120 and the terminal device 130 as shown in FIG. 1. For the purpose of discussion, the method 500 will be described with reference to FIG. 1 as performed by the terminal device 120 without loss of generality.

At block 510, the terminal device 120 determines a signal duration of an extension signal based on a first variable and a second variable. In some embodiments, the extension signal may comprise a Cyclic Prefix Extension (CPE) signal.

At block 520, the terminal device 120 transmits the extension signal before performing a sidelink communication.

In some embodiments, the terminal device 120 may determine the signal duration of the extension signal as a duration of a first number of symbols minus the second variable. The first number is equal to the first variable.

In some embodiments, the terminal device 120 may determine the signal duration of the extension signal based on the following:

$${T}_{ext} = {\sum }_{k = 1}^{C} {T}_{symb , ( l - k ) mod 7 \cdot {2}^{μ}}^{μ} - Δ \qquad ( 1 )$$

where Tₑₓₜ represents the signal duration of the extension signal, C represents the first variable, Δ represents the second variable, l represents an OFDM symbol, i.e., a start symbol of a sidelink signal, and μ represents a subcarrier spacing (SCS) configuration. For example, μ may be determined based on the following:

| μ | Δf = 2^{μ} · 15[kHz] |
|---|---|
| 0 | 15 |
| 1 | 30 |
| 2 | 60 |
| 3 | 120 |
| 4 | 240 |

In some embodiments, the terminal device 120 may generate the extension signal based on the following:

$${s}_{ext}^{( p , μ )} ( t ) = {\overline{s}}_{l}^{( p , μ )} ( t ) for {t}_{start , l}^{μ} - {T}_{ext} \leq t < {t}_{start , l}^{μ} \qquad ( 2 )$$

where sₑₓₜ^{(p,μ)}(t) represents the extension signal on an antenna port p, i.e. the signal transmitted preceding the OFDM symbol l, s̅ₗ^{(p,μ)}(t) represents the signal transmitted in the OFDM symbol l.

With the solution of present disclosure, the terminal device may transmit the extension signal before the start symbol of sidelink transmission. By transmitting the extension signal, the terminal device can occupy channel resource in unlicensed spectrum after a channel access procedure succeeds and hold the channel occupancy for following actual sidelink information transmission.

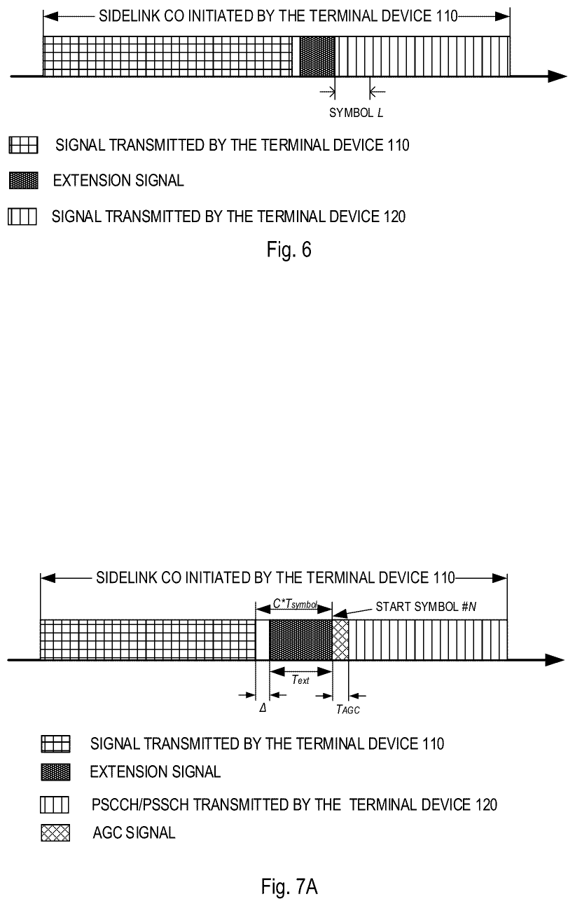

FIG. 6 illustrates an example of sidelink transmission in accordance with some embodiments of the present disclosure. In the example of FIG. 6, within a sidelink CO initiated by the terminal device 110, the terminal device 110 performs sidelink signal transmission starting from the beginning of the CO and the remaining resources after its transmission can be shared by the terminal device 120. The terminal device 120 should determine whether and how long an extension signal should be transmitted before the next available start symbol for sidelink transmission in the CO. In other words, the terminal device 120 should determine the signal duration of the extension signal. Then, the terminal device 120 transmits the extension signal with the determined signal duration.

It should be noted that although it is not shown in FIG. 6, the terminal device 110 may also transmit an extension signal before performing the sidelink signal transmission. In this case, the terminal device 110 may determine a signal duration of the extension signal by using the solution of the present disclosure.

In some embodiments, the first variable may be in the range of [0,1,2, . . . , maximum value]. The maximum value may be pre-configured or pre-defined. For example, the maximum value may be pre-configured or pre-defined as 7·2^{μ}, where μ represents an SCS configuration. of course, other maximum value may be also applied to the present disclosure.

In some embodiments, the second variable may be a configured or pre-configured fixed value. For example, the second variable may be T μs.

Alternatively, the second variable may be equal to a time gap related to a channel access procedure. The channel access procedure may be also referred to as a Clear Channel Assessment (CCA) procedure. Thus, the terms “channel access” and “CCA” may be used interchangeably. Hereinafter, the time gap related to a channel access procedure may be represented by T_{GP}. For example, T_{GP}=16, 25, 18, or 27 μs.

Alternatively, the second variable may be equal to a time gap related to an Automatic Gain Control (AGC) procedure. Hereinafter, the time gap related to an AGC procedure may be represented by T_{AGC}. For example, T_{AGC} may be equal to a fixed value configured or pre-configured per SCS. Alternatively, the time gap related to the AGC procedure may be determined based on a pre-defined parameter associated with the SCS. For example, the time gap related to the AGC procedure may be determined based on the following:

$${T}_{AGC} = {N}_{AGC} * {T}_{C} , \qquad ( 3 )$$

where N_{AGC}=N*K*2^{-μ}, N_{AGC} represents the pre-defined parameter associated with the SCS, N is an integer number, T_{C}=1/(480·10^{3·}4096), and K=64.

Alternatively, the second variable may be equal to a sum of at least two of the following: T, T_{GP} and T_{AGC}.

In some embodiments, the terminal device 120 may determine the first variable and the second variable based on at least one of the following: a parameter list of the extension signal; assignment information; a resource structure in a sidelink CO; or a type of a channel access procedure.

In some embodiments, the sidelink CO may be at least one of the following: a CO initiated by a sidelink terminal device, or a CO which contains a sidelink transmission, a CO which contains a sidelink channel. In some embodiments, the sidelink transmission may comprise at least one of sidelink transmission and Uu transmission within the CO.

In some embodiments, the sidelink CO may be a CO initiated by a control node device for sidelink especially.

In some embodiments, the parameter list of the extension signal may be determined based on at least one of the following: a system pre-definition; a pre-configuration; or a configuration.

In some embodiments, the assignment information may indicate at least one of the first variable and the second variable. The terminal device 120 may receive the assignment information from a control node device.

In some embodiments, the control node device may comprise a network device, for example, the network device 140 or 150 in FIG. 1. Alternatively, the control node device may comprise a road side unit (RSU). Alternatively, the control node device may comprise a header terminal device in a sidelink communication group, a terminal device paired for sidelink unicast communication, or a further terminal device which may be different from the header terminal device and the terminal device paired for sidelink unicast communication. For example, each of the header terminal device, the terminal device paired for sidelink unicast communication and the further terminal device may be one of, the terminal devices 110 and 130 in FIG. 1.

In some embodiments, the terminal device 120 may receive the configuration from the control node device, the configuration indicating the parameter list of the extension signal. Alternatively, the parameter list of the extension signal may be pre-defined or preconfigured.

In some embodiments, the parameter list of the extension signal may comprise at least one of the following: a first list of available values of the first variable, wherein each of the available values is associated with a first index; a second list of available values of the second variable, wherein each of the available values is associated with a second index; or a third list of available values of the first variable and available values of the second variable, wherein each of combinations of an available value of the first variable and an available value of the second variable is associated with a third index.

Table 1, Table 2 and Table 3 show an example of the first list, the second list, and the third list, respectively.

TABLE 1

| index i | Cᵢ |
|---|---|
| 0 | 0 |
| 1 | 1 |
| 2 | 2 |
| 3 | 4 |
| 4 | 8 |
| 5 | 10 |
| 6 | 14 |
| 7 | reserved |

TABLE 2

| index t | Δₜ |
|---|---|
| 0 | 0 |
| 1 | T μs |
| 2 | T_{GP} |
| 3 | T_{AGC} |
| 4 | T + T_{GP} |
| 5 | T + T_{AGC} |
| 6 | T_{GP} + T_{AGC} |
| 7 | T + T_{GP} + T_{AGC} |

TABLE 3

| index g | C_{g} | Δ_{g} |
|---|---|---|
| 0 | 0 | 0 |
| 1 | 1 | 0 |
| 2 | 2 | 0 |
| 3 | 4 | 0 |
| 4 | 1 | T |
| 5 | 1 | T_{GP} |
| 6 | 1 | T_{AGC} |
| 7 | 1 | T + T_{GP} |
| 8 | 1 | T + T_{AGC} |
| 9 | 1 | T_{GP} + T_{AGC} |
| 10 | 1 | T + T_{GP} + T_{AGC} |
| 11 | 2 | T |
| 12 | 2 | T_{GP} |
| 13 | 2 | T_{AGC} |
| 14 | 2 | T + T_{GP} |
| 15 | 2 | T + T_{AGC} |
| 16 | 2 | T_{GP} + T_{AGC} |
| 17 | 2 | T + T_{GP} + T_{AGC} |
| . . . | | |
| . . . | | |
| 49-63 | reserved | reserved |

The first index is represented by i in Table 1, the second index is represented by t in Table 2, and the third index is represented by g in Table 3.

In some embodiments, the assignment information may indicate at least one of the following: the first index in the first list; the second index in the second list; or the third index in the third list. For example, the assignment information may indicate the first variable C and the second variable Δ by indicating the first index and the second index, respectively. Alternatively, the assignment information may indicate the first variable C and the second variable Δ by indicating the third index.

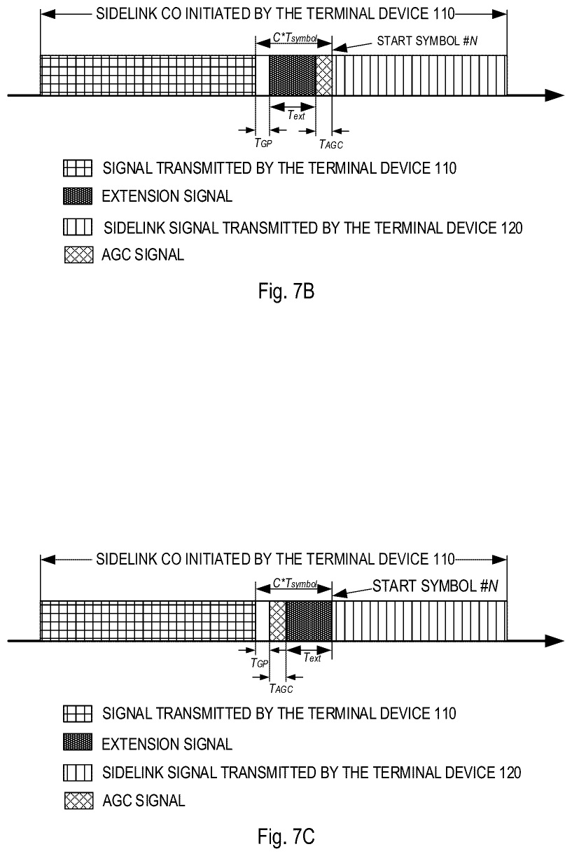

Based on the first variable C and the second variable Δ, the terminal device 120 may perform the CCA procedure and transmit the extension signal and corresponding sidelink signal, which will be described with reference to FIGS. 7A, 7B and 7C.

FIGS. 7A, 7B and 7C illustrate an example of sidelink transmission in accordance with some embodiments of the present disclosure, respectively. In FIGS. 7A, 7B and 7C, T_{symbol} represents a duration of a symbol. For example, the symbol may include but is not limited to an OFDM symbol.

In the example of FIG. 7A, C=1 and Δ=T_{GP}=25 μs which are pre-defined, and the terminal device 120 transmits the extension signal before a start symbol for sidelink transmission. It should be noted that in the example of FIG. 7A, the sidelink transmission includes transmissions of AGC signal and sidelink signal (for example, PSCCH or PSSCH).

In the example of FIG. 7B, C=2 and 0=T_{GP}+T_{AGC} which are pre-defined, and the terminal device 120 transmits the extension signal before transmitting an AGC signal. It should be noted that in the example of FIG. 7B, the AGC signal is fixed and transmitted before the start symbol #N of sidelink transmission, and the extension signal is transmitted before the AGC signal.

In the example of FIG. 7C, the terminal device 120 transmits the AGC signal before the extension signal and then the actual sidelink information transmission.

In some embodiments, the terminal device 120 may transmit the extension signal before transmitting a sidelink signal.

As mentioned above, the terminal device 120 may determine the first variable and the second variable based on at least one of the following: a parameter list of the extension signal; assignment information; a resource structure in a sidelink CO

In embodiments where the first variable and the second variable are determined based on the resource structure in a sidelink CO, the first variable and the second variable may be determined based on pre-defined rules implicitly. In this way, no additional signaling overhead is needed.

In such embodiments, the first variable C may be implicitly determined by the terminal device 120 based on locations of a last symbol (symbol #M) of a transmission burst and a next available start symbol (symbol #N) for sidelink transmission in the sidelink CO, i.e., C=N−M−1.

In such embodiments, Δ may be implicitly determined based on a type of a CCA procedure. Hereinafter, the type of the CCA procedure may be also referred to as CCA type. In such embodiments, Δ may be determined as a respective fixed value for each CCA type or a respective fixed value plus the time gap (T_{AGC}) related to the AGC procedure for each CCA type. For example, Δ may be determined as the following:

$$Δ = \{ \begin{matrix}25 & μs for CCA type 2 A \\ 16 & μs for CCA type 2 B \\ 0 & for CCA type 2 C\end{matrix} ; or \qquad ( 4 )$$

$$Δ = \{ \begin{matrix}{T}_{AGC} + 25 & μs for CCA type 2 A \\ {T}_{AGC} + 16 & μs for CCA type 2 B \\ {T}_{AGC} & for CCA type 2 C\end{matrix} \qquad ( 5 )$$

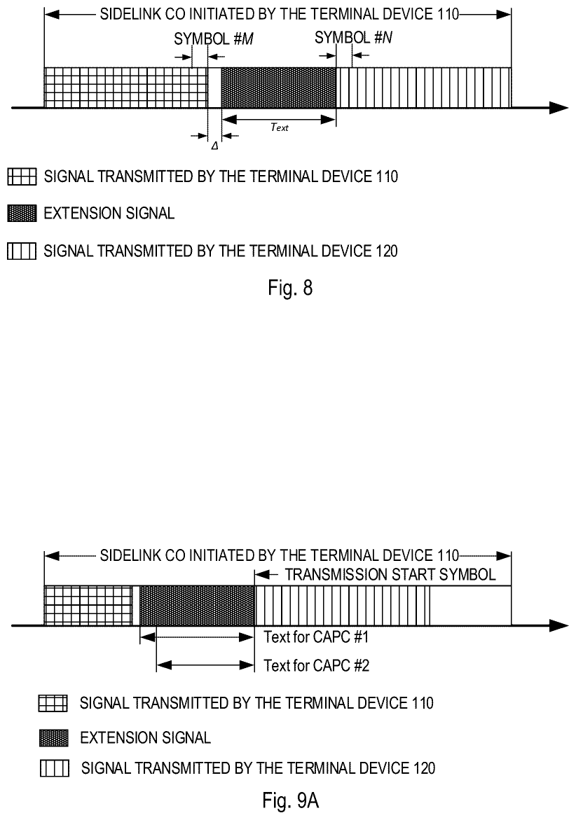

FIG. 8 illustrates an example of sidelink transmission in accordance with some embodiments of the present disclosure. In the example of FIG. 8, the first variable C and the second variable Δ are determined implicitly. For example, the terminal device 120 may determine C and Δ according to the situation of a sidelink CO initiated by the terminal device 110.

As shown in FIG. 8, within the CO, the terminal device 110 transmits a sidelink signal from a beginning of the CO until symbol #M. After that, the terminal device 120 performs a CCA procedure of type 2A to share remaining resources in the CO. The terminal device 110 may transmit configuration information about the CO in SCI, including the available transmission start symbol for sidelink and sidelink channel allocation in the CO.

Based on the configuration information about the CO, the terminal device 120 would transmit practical signal from symbol #N and the extension signal before symbol #N. The signal duration of the extension signal is determined as:

$${T}_{ext} = {\sum }_{k = 1}^{C} {T}_{symb , ( l - k ) mod 7 \cdot {2}^{μ}}^{μ} - Δ$$

where C=N−M−1, Δ=25 μs.

In some embodiments, the parameter list of the extension signal may comprise a fifth list of combinations of at least two of the following: the first index in the first list; the second index in the second list; the third index in the third list; a type of a channel access procedure; a Channel Access Priority Class (CAPC). Each of the combinations is associated with a fifth index. In such embodiments, the assignment information may indicate the fifth index in the fifth list.

Table 4 and Table 5 show an example of the fifth list, respectively.

TABLE 4

| index j | CCA type | index i of Cᵢ in Table 1 |
|---|---|---|
| 0 | Type 2A | 0 |
| 1 | Type 2A | 1 |
| 2 | Type 2A | 4 |
| 3 | Type 2B | 0 |
| 4 | Type 2B | 3 |
| 5 | Type 2B | 5 |
| 6 | Type 2C | 3 |
| 7 | reserved | reserved |

TABLE 5

| index k | CAPC | index t of Δₜ in Table 2 |
|---|---|---|
| 0 | 1 | 0 |
| 1 | 2 | 1 |
| 2 | 3 | 2 |
| 3 | 4 | 3 |
| 4 | 1 | 5 |
| 5 | 2 | 6 |
| 6 | 3 | 7 |
| 7 | reserved | reserved |

In some embodiments, the available values of the first variable C₁ and the second variable Δₜ are pre-defined in system as shown in Table 1 and Table 2. Based on that, the control node device may further indicate a combination of the first variable C₁ and CCA type, as shown in Table 4, and a combination of the second variable Δₜ and CAPC, as shown in

Table 5. Such embodiments provide further configuration flexibility for the control node device.

In Table 4, the fifth index is represented by j and assigns a CCA type and an index i of the first variable Cᵢ. In

Table 5, the fifth index is represented by k and assigns CAPC and an index t of Δₜ.

Furthermore, the control node device may configure items in Table 4 and

Table 5 through PC5 or an RRC signaling, and then indicate suitable index j and index k to the terminal device 120 in SCI or DCI.

For the terminal device 120, it should receive the items as shown in Table 4 and

Table 5 from the control node device and the assignment of index j and index k from SCI or DCI. Based on the indication, the terminal device 120 should determine the first and second variables, and transmit the extension signal accordingly.

Table 6 shows another example of the fifth list. In Table 6, the fifth index is represented by j.

TABLE 6

| | | | index i of Cᵢ | index t of Δₜ |
|---|---|---|---|---|
| index j | CAPC | CCA type | in Table 1 | in Table 2 |
| 0 | 1 | Type 2A | 0 | 0 |
| 1 | 2 | Type 2A | 1 | 1 |
| 2 | 3 | Type 2A | 2 | 2 |
| 3 | 4 | Type 2A | 4 | 3 |
| 4 | 1 | Type 2A | 3 | 0 |
| 5 | 2 | Type 2A | 4 | 5 |
| 6 | 3 | Type 2A | 5 | 6 |
| 7 | 4 | Type 2A | 6 | 7 |
| 8 | 1 | Type 2B | 1 | 0 |
| 9 | 2 | Type 2B | 2 | 1 |
| 10 | 3 | Type 2B | 3 | 2 |
| 11 | 4 | Type 2B | 4 | 3 |
| 12 | 1 | Type 2C | 1 | 0 |
| 13 | 2 | Type 2C | 2 | 1 |
| 14 | 3 | Type 2C | 3 | 2 |
| 15 | 4 | Type 2C | 4 | 3 |

In some embodiments, the available values of the first variable Cᵢ and the second variable Δₜ are pre-defined in system as shown in Table 1 and Table 2. The control node device may further indicate a combination of the first variable Cᵢ, the second variable Δₜ, CAPC and CCA type, as shown in Table 6. According to Table 6, an index j assigns a CCA type, CAPC, an index i of the first variable Cᵢ and an index t of the second variable Δₜ.

For the terminal device 120, it should receive the items as shown in Table 6 from the control node device and the assignment of index j from SCI or DCI. Based on the indication, the terminal device 120 determines the first variable Cᵢ and the second variable Δₜ, and transmits the extension signal accordingly.

Table 7 shows another example of the fifth list. In Table 7, the fifth index is represented by j.

TABLE 7

| index j | CAPC | CCA type | index i of Cᵢ in Table 1 |
|---|---|---|---|
| 0 | 1 | Type 2A | 1 |
| 1 | 2 | Type 2A | 2 |
| 2 | 3 | Type 2A | 3 |
| 3 | 4 | Type 2A | 4 |
| 4 | 1 | Type 2A | 3 |
| 5 | 2 | Type 2A | 4 |
| 6 | 3 | Type 2A | 5 |
| 7 | 4 | Type 2A | 6 |
| 8 | 1 | Type 2B | 1 |
| 9 | 2 | Type 2B | 2 |
| 10 | 3 | Type 2B | 3 |
| 11 | 4 | Type 2B | 4 |
| 12 | 1 | Type 2C | 1 |
| 13 | 2 | Type 2C | 2 |
| 14 | 3 | Type 2C | 3 |
| 15 | 4 | Type 2C | 4 |

In some embodiments, the available values of the first variable Cᵢ is pre-defined in system as shown in Table 1 and the second variable may be determined implicitly. The control node device may further indicate a combination of CAPC, CCA type and index of Cᵢ through an RRC signaling, as shown in Table 7. According to Table 7, an index j assigns a CCA type, CAPC, and an index i of Cᵢ.

For the terminal device 120, it should receive the items as shown in Table 7 from the control node device and the assignment of index j from DC Based on the indication, the terminal device 120 determines the first variable Cᵢ. In addition, the terminal device 120 may determine the second variable based on one of the equations (4) and (5) as described above. Then, the terminal device 120 transmits the extension signal accordingly.

In some embodiments, the parameter list of the extension signal may comprise a fourth list of combinations of at least three of the following: the first variable; the second variable; a type of a channel access procedure; a CAPC. Each of the combinations is associated with a fourth index. In such embodiments, the assignment information may indicate the fourth index in the fourth list.

Table 8 shows another example of the fourth list. In Table 8, the fourth index is represented by j.

TABLE 8

| index j | CAPC | CCA type | C | Δ |
|---|---|---|---|---|
| 0 | 1 | Type 2A | 0 | 0 |
| 1 | 2 | Type 2A | 1 | T μs |
| 2 | 3 | Type 2A | 2 | T_{GP} |
| 3 | 4 | Type 2A | 8 | T_{AGC} |
| 4 | 1 | Type 2A | 4 | 0 |
| 5 | 2 | Type 2A | 8 | T + T_{AGC} |
| 6 | 3 | Type 2A | 10 | T_{GP} + T_{AGC} |
| 7 | 4 | Type 2A | 14 | T + T_{GP} + T_{AGC} |
| 8 | 1 | Type 2B | 1 | 0 |
| 9 | 2 | Type 2B | 2 | T μs |
| 10 | 3 | Type 2B | 4 | T_{GP} |
| 11 | 4 | Type 2B | 8 | T_{AGC} |
| 12 | 1 | Type 2C | 0 | 0 |
| 13 | 2 | Type 2C | 1 | T μs |
| 14 | 3 | Type 2C | 2 | T_{GP} |
| 15 | 4 | Type 2C | 4 | T_{AGC} |

In some embodiments, the control node device assigns a combination of the first variable C, the second variable Δ, CAPC and CCA type, as shown in Table 8. According to Table 8, an index j assigns a CCA type, CAPC, the first variable C, and the second variable Δ.

For the terminal device 120, it should receive the items as shown in Table 8 from the control node device and the assignment of index j from SCI or DCI. Based on the indication, the terminal device 120 determines the first variable C and the second variable Δ, and transmits the extension signal accordingly.

In some embodiments, the parameter list of the extension signal may be configured or pre-configured per CAPC or CCA type. For each CAPC or CCA type, independent parameter list of the extension signal may be assigned by using any one of the scheme or combination as described above. As CAPC presents the priority of information to be transmitted, the parameter list of the extension signal assigned per CAPC may provide different access opportunities for each CAPC. In addition, the parameter list of the extension signal assigned per CCA type have similar benefit.

In some embodiments, the parameter list of the extension signal is pre-configured per CAPC, including:
For CAPC #1, C=4 and Δ=0;
For CAPC #2, C=2 and Δ=T μs;
For CAPC #3, C=2 and Δ=0;
For CAPC #4, C=1 and Δ=T μs.

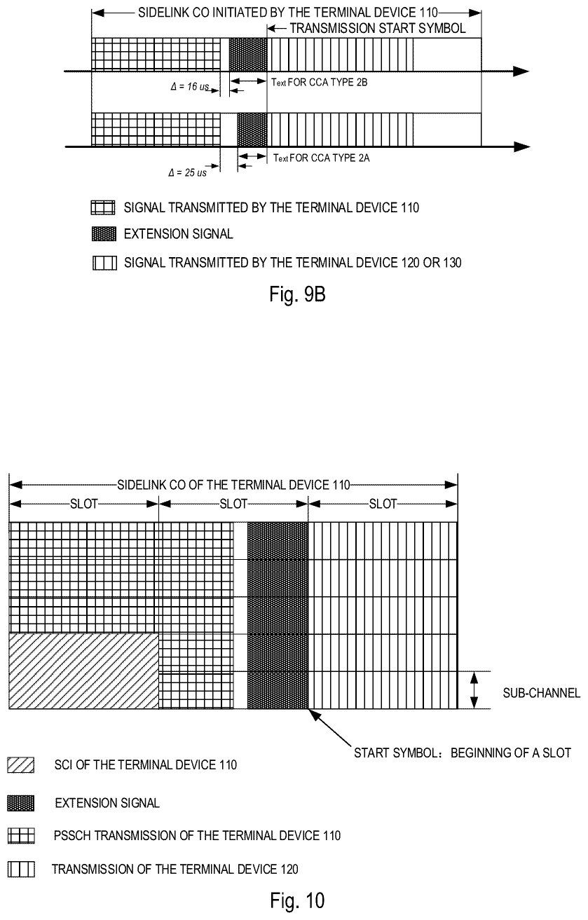

Based on the pre-configuration, within a sidelink CO initiated by the terminal device 110, remaining resources in the CO may be shared by one or more other terminal devices. This will be described with reference to FIG. 9A.

FIG. 9A illustrates an example of sidelink transmission in accordance with some embodiments of the present disclosure. In the example of FIG. 9A, for the terminal device 120, the sidelink information to be transmitted has CAPC #1, while for the terminal device 130, the sidelink information to be transmitted has CAPC #2. According to the pre-configuration and indication of the terminal device 110, the terminal device 120 and the terminal device 130 may perform respective CCA procedure and try to access to channel. As available values of the first variable and the second variable are different for each CAPC, before the common transmission start symbol, the signal duration Tₑₓₜ of the extension signal of the terminal device 120 is larger than that of the terminal device 130. In other words, the terminal device 120 may have higher possibility to occupy the channel.

In some embodiments, the parameter list of the extension signal is pre-configured per CCA type, including:
For CCA type 2A, C=1 for μ∈{0,1}, C=2 for μ=2, and Δ=25 μs;
For CCA type 2B, C=2 and Δ=16 μs;
For CCA type 2C, C=4 and Δ=0.

FIG. 9B illustrates an example of sidelink transmission in accordance with some embodiments of the present disclosure. In the example of FIG. 9B, the terminal device 120 uses CCA type 2B to access to channel, while the terminal device 130 uses CCA type 2A to access to channel. According to the pre-configuration and indication of the terminal device 110, the terminal device 120 and the terminal device 130 should determine the first variable and the second variable for corresponding CCA type. As shown, for CCA type 2B, Δ=16 μs and for CCA type 2A, Δ=25 μs. Thus, the signal duration Tₑₓₜ of the extension signal of the terminal device 120 is larger than that of the terminal device 130. In this way, the terminal device 120 using CCA type 2B may have higher possibility to occupy the channel.

In some embodiments, the parameter list of the extension signal may be configured or pre-configured based on a resource pool for sidelink communication, a Resource Block (RB) set, a Bandwidth Part (BWP), a carrier, a sidelink Channel Occupancy (CO), or a transmission start symbol for sidelink within the sidelink CO. The terminal device 120 working on corresponding resource pool, RB set, BWP or carrier may select at least one of the first variable and the second variable from the configured available values by itself, and then perform transmission of an extension signal.

With different configuration granularity of the parameter list of the extension signal, it can provide more configuration and management flexibility for sidelink communication in unlicensed spectrum.

In some embodiments, several resource pools are configured for sidelink communication and each resource pool may be used for different cast type, sidelink group or manage node, and so on. For each resource pool, the parameter list of the extension signal may be assigned independently. For example, for resource pool used for different group, the parameter list of the extension signal may be assigned by a header terminal device of the group according to the requirement of the groupcast.

For the terminal device 120 working in resource pool #1, the parameter list of the extension signal may include the following:
C=[0,1,4,8];
Δ=[0, 25 μs];

Then, the terminal device 120 may select suitable C and Δ for transmission of the extension signal.

Similar to the embodiments where the parameter list of the extension signal is configured per resource pool, independent parameter list of the extension signal may be assigned per RB set, per BWP, or per carrier.

In some embodiments, the parameter list of the extension signal may be configured or pre-configured per sidelink CO. The parameter list of the extension signal may be assigned by the terminal device 110 which initiates the CO. The terminal device 110 may indicate the parameter list of the extension signal through SCI. In such embodiments, the terminal device 110 may assign the CO sharing configuration in the CO. This will be described with reference to FIG. 10.

FIG. 10 illustrates an example of sidelink transmission in accordance with some embodiments of the present disclosure. In the example of FIG. 10, the terminal device 110 initiates a sidelink CO and assigns a common configuration for the sidelink CO in SCI. The indication items in the SCI includes: channel configuration, available CCA type and CAPC for terminal devices 120 and 130, available transmission start symbols for sidelink, C and Δ in the sidelink CO.

According to the SCI, the terminal device 120 may determine whether it can transmit its sidelink information using resources in the CO. If yes, after a CCA procedure succeeds, the terminal device 120 may determine whether and how long an extension signal needs to be transmitted.

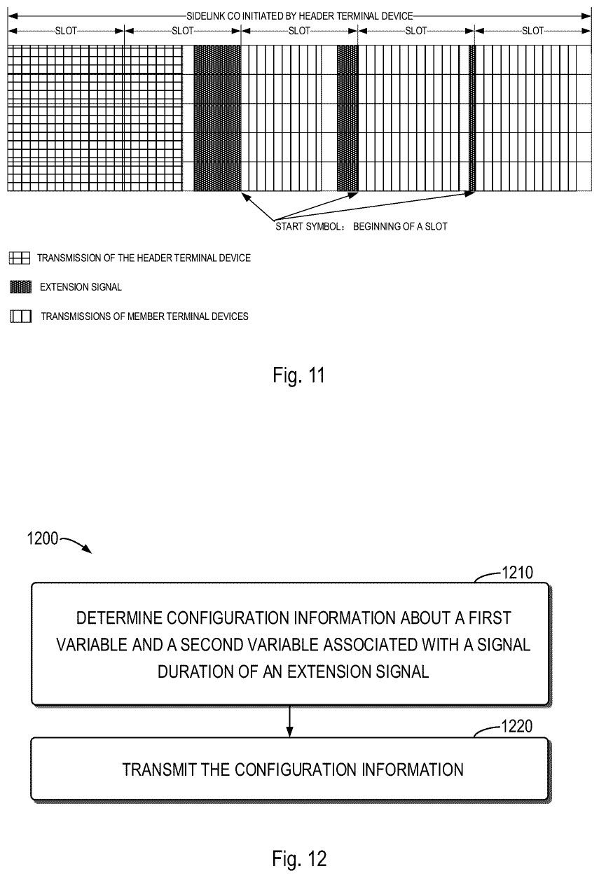

In some embodiments, within a sidelink CO, there may be more than one transmission start symbols for sidelink transmission which are pre-configured or configured by the terminal device 110. In such embodiments, the parameter list of the extension signal may be configured or pre-configured per transmission start symbols for sidelink within the sidelink CO. In this way, the parameter list of the extension signal per transmission start symbol for sidelink may be used to assign different channel access possibility for diverse types of information or CAPC. This will be described with reference to FIG. 11.

FIG. 11 illustrates an example of sidelink transmission in accordance with some embodiments of the present disclosure. In the example of FIG. 11, a header terminal device (for example, the terminal device 110) in a sidelink communication group initiates a sidelink CO and shares the CO with member terminal devices (for example, the terminal devices 120 and 130) in the same group. According to a per-configured resource structure, there are several transmission start symbols are allocated within the CO. As shown, there are three transmission start symbols are allocated within the CO.

Furthermore, the header terminal device may indicate a combined configuration of CCA type, CAPC and available values of the first and second variables for each start symbol through a PC5 signaling, as listed in below Table 9.

TABLE 9

| Index of | | | | |
|---|---|---|---|---|
| start | | | | |
| symbol | CAPC | CCA type | C | Δ |
| 1 | 1 | Type 2B | 7 | T_{AGC} |
| 2 | 2 | Type 2A | 4 | 25 μs + T_{AGC} |
| 3 | 3 | Type 2A | 1 | 25 μs |

For example, according to the combined configuration from header terminal device, member terminal devices may use proper start symbol and available values of the first and second variables to access channel.

For example, one member terminal device may transmit sidelink signal with CAPC 1, and then the member terminal device should use the start symbol 1, and determine, based on Table 9, the first variable C and the second variable Δ as 7 and T_{AGC}, respectively. Another member terminal device may transmit sidelink signal with CAPC 2, and then the member terminal device should use the start symbol 2, and determine, based on Table 9, the first variable C and the second variable Δ as 4 and 25 μs+T_{AGC}, respectively. Yet another member terminal device may use the start symbol 3, and determine, based on Table 9, the first variable C and the second variable Δ as 1 and 25 μs, respectively.

As mentioned above, the control node device may comprise one of the following: a network device, a road side unit, a header terminal device in a sidelink communication group, a terminal device paired for sidelink unicast communication, or a further terminal device.

In embodiments where the control node device comprises a network device, the network device may transmit configuration information about the first and second variables through an RRC signaling. In such embodiments, the network device may initiate a CO and indicates scheduling information to the terminal device 120 in DCI. The terminal device 120 transmits an extension signal according to the indication of the network device. Such embodiments may be used for hybrid CO sharing, i.e. Uu and sidelink communication within the same CO. It supports sidelink transmission scheduled by the network device (mode 1) in a CO initiated by the network device.

For example, the network device initiates a CO and schedules resources in the CO for sidelink communication. In order to assign suitable configuration about the first and second variables for sidelink terminal devices, the network device may indicate available configuration dedicated for sidelink using an RRC signaling, e.g., System Information Block (SIB). Furthermore, the network device may schedule resources and configuration about the first and second variables for a sidelink terminal device. According to the indication, the sidelink terminal device should use the assigned resource and configuration about the first and second variables to access channel in the CO initiated by the network device.

In embodiments where the control node device comprises an RSU, the RSU may transmit configuration information about the first and second variables through PC5 broadcast. The RSU may initiate a CO and indicate scheduling information to a sidelink terminal device in SCI. The sidelink terminal device determines the first and second variables involved in the assigned configuration. Such embodiments for RSU managing configuration about the first and second variables is similar to embodiments described with reference to FIG. 11.

For example, the RSU broadcasts an available configuration about the first and second variables periodically which includes several items of a combination of CCA type, CAPC and corresponding first and second variables, an example of which is shown in Table 8.

Based on the configuration about the first and second variables, a sidelink terminal device covered by the RSU (or sharing sidelink CO initiated by the RSU) may use the items included in Table 8. In other words, the sidelink terminal device should determine configuration about the first and second variables according to the assignment of RSU and other factors relevant to CCA procedure.

FIG. 12 illustrates a flowchart of an example method 1200 in accordance with some embodiments of the present disclosure. In some embodiments, the method 1200 can be implemented at a control node device, such as one of the terminal devices 110 and 130 or one of the network devices 140 and 150 as shown in FIG. 1. For the purpose of discussion, the method 1200 will be described with reference to FIG. 1 as performed by the network device 140 without loss of generality.

At block 1210, the control node device determines configuration information about a first variable and a second variable associated with a signal duration of an extension signal.

At block 1220, the control node device transmits the configuration information.

In some embodiments, the signal duration is determined as a duration of a first number of symbols minus the second variable, the first number being equal to the first variable.

In some embodiments, the configuration information comprises at least one of the following: a parameter list of the extension signal; or assignment information.

In some embodiments, the assignment information indicates at least one of the first variable and the second variable.

In some embodiments, the parameter list of the extension signal comprises at least one of the following: a first list of available values of the first variable, In some embodiments, each of the available values is associated with a first index; a second list of available values of the second variable, In some embodiments, each of the available values is associated with a second index; or a third list of available values of the first variable and available values of the second variable. Each of combinations of an available value of the first variable and an available value of the second variable is associated with a third index.

In some embodiments, the parameter list of the extension signal comprises a fourth list of combinations of at least three of the following: the first variable; the second variable; a type of a channel access procedure; or a Channel Access Priority Class (CAPC); and In some embodiments, each of the combinations is associated with a fourth index.

In some embodiments, the parameter list of the extension signal comprises a fifth list of combinations of at least two of the following: the first index; the second index; the third index; a type of a channel access procedure; or a Channel Access Priority Class (CAPC). Each of the combinations is associated with a fifth index.

In some embodiments, the assignment information indicates at least one of the following: the first index in the first list; the second index in the second list; or the third index in the third list.

In some embodiments, the assignment information indicates the fourth index in the fourth list.

In some embodiments, the assignment information indicates the fifth index in the fifth list.

In some embodiments, the configuration information further comprises a maximum value of the first variable.

In some embodiments, determining the configuration information about a first variable and a second variable comprises: determining the second variable as at least one of the following: a first fixed value, a time gap related to a channel access procedure, or a time gap related to an Automatic Gain Control (AGC) procedure.

In some embodiments, additionally, the control node device determines the time gap related to the AGC procedure as a second fixed value per subcarrier spacing (SCS).

In some embodiments, the parameter list is determined based on at least one of the following: a resource pool for sidelink communication, a Resource Block (RB) set, a Bandwidth Part (BWP), a carrier, a sidelink Channel Occupancy (CO), or a transmission start symbol within the sidelink CO.

In some embodiments, the control node device comprises one of the following: a network device, a road side unit, a header terminal device in a sidelink communication group, a terminal device paired for sidelink unicast communication, or a further terminal device.

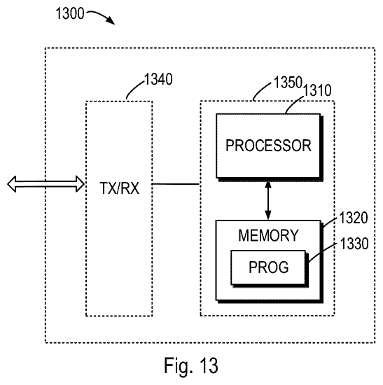

FIG. 13 is a simplified block diagram of a device 1300 that is suitable for implementing some embodiments of the present disclosure. The device 1300 can be considered as a further example embodiment of the terminal device 120 or the network device 140 as shown in FIG. 1. Accordingly, the device 1300 can be implemented at or as at least a part of the terminal device 120 or the network device 140.

As shown, the device 1300 includes a processor 1310, a memory 1320 coupled to the processor 1310, a suitable transmitter (TX) and receiver (RX) 1340 coupled to the processor 1310, and a communication interface coupled to the TX/RX 1340. The memory 1320 stores at least a part of a program 1330. The TX/RX 1340 is for bidirectional communications. The TX/RX 1340 has at least one antenna to facilitate communication, though in practice an Access Node mentioned in this application may have several ones. The communication interface may represent any interface that is necessary for communication with other network elements, such as X2 interface for bidirectional communications between gNBs or eNBs, Si interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1330 is assumed to include program instructions that, when executed by the associated processor 1310, enable the device 1300 to operate in accordance with the embodiments of the present disclosure, as discussed herein with reference to FIGS. 5 to 14. The embodiments herein may be implemented by computer software executable by the processor 1310 of the device 1300, or by hardware, or by a combination of software and hardware. The processor 1310 may be configured to implement various embodiments of the present disclosure. Furthermore, a combination of the processor 1310 and memory 1320 may form processing means 1350 adapted to implement various embodiments of the present disclosure.

The memory 1320 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1320 is shown in the device 1300, there may be several physically distinct memory modules in the device 1300. The processor 1310 may be of any type suitable to the local technical network, and may include one or more of general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 1 to 12. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-41. (canceled)

42. A method performed by a terminal device, comprising:
receiving a configuration including a set of indices associated per priority, the indices corresponding to variables for Cyclic Prefix Extension (CPE) to be used for a sidelink transmission;
determining a duration of the CPE based on the variables; and
applying the CPE to a start symbol of the sidelink communication.

43. The method of claim 42, wherein the terminal device is a first terminal device to initiate a channel occupancy or a second terminal device transmitting within a channel occupancy.

44. The method of claim 42, further comprising: further comprising determining the duration of the CPE based on a gap between a first sidelink transmission and a second sidelink transmission following the first sidelink transmission in a channel occupancy.

45. The method of claim 42, wherein determining the duration comprising: selecting an index from the set of indices associated per priority.

46. A terminal device, comprising:
a processor configured to:
receive a configuration including a set of indices associated per priority, the indices corresponding to variables for Cyclic Prefix Extension (CPE) to be used for a sidelink transmission;
determine a duration of the CPE based on the variables; and
apply the CPE to a start symbol of the sidelink transmission.

47. The terminal device of claim 46, wherein the terminal device is a first terminal device to initiate a channel occupancy or a second terminal device transmitting within a channel occupancy.

48. The terminal device of claim 46, wherein the processor is further configured to cause the terminal device to determine the duration of the CPE based on a gap between a first sidelink transmission and a second sidelink transmission following the first sidelink transmission in a channel occupancy.

49. The terminal device of claim 46, wherein the processor is configured to cause the terminal device to determine the duration by selecting an index from the set of indices associated per priority.
